(19) United States
(12) Patent Application Publication
(10) Pub. No.: US 2015/0237145 A1
(43) Pub. Date: Aug. 20, 2015

(54) INFORMATION PROCESSING SYSTEM AND METHOD

(71) Applicant: FUJITSU LIMITED, Kawasaki-shi (JP)

(72) Inventors: Takahiro Koseki, Kawasaki (JP); Keiji Shimatani, Nerima (JP)

(73) Assignee: FUJITSU LIMITED, Kawasaki (JP)

(21) Appl. No.: 14/591,347

(22) Filed: Jan. 7, 2015

(30) Foreign Application Priority Data
Feb. 14, 2014 (JP) 2014-026538

(51) Int. Cl. H04L 29/08

(52) U.S. Cl. CPC H04L 67/141; H04L 67/10

(57) ABSTRACT

An information processing system includes a first device that outputs a first access request conforming to a first communication protocol, a first relay device that converts the first access request into a second access request conforming to the second communication protocol and outputs the second access request, a second relay device that converts the second access request into a third access request conforming to the first communication protocol and outputs the third access request, and a second device outputs data, based on the third access request, wherein the first relay device receives the data via the second relay device and holds the data, after which the first relay device receives a fourth access request from the first device and outputs the data held therein to the first device.

### CROSS-REFERENCE TO RELATED APPLICATION

This application is based upon and claims the benefit of priority of the prior Japanese Patent Application No. 2014-026538, filed on Feb. 14, 2014, the entire contents of which are incorporated herein by reference.

### FIELD

The embodiments discussed herein are an information processing system and method.

### BACKGROUND

A technique is proposed for causing a proxy server disposed between an intranet and the Internet to hold a document received via the Internet in its cache and send it to a requestor without accessing the Internet. In addition, another technique is proposed for coupling a computer to a controller for an inter-integrated circuit (I2C (trademark)) device via a network and enabling this computer to access the I2C device. Exemplary relevant documents are Japanese Laid-open Patent Publication No. 2000-57041 and AnaGateI2C Datasheet (Analytica GmbH).

### SUMMARY

According to an aspect of the invention, an information processing system includes a first device that outputs a first access request conforming to a first communication protocol, a first relay device that converts the first access request into a second access request conforming to the second communication protocol and outputs the second access request, a second relay device that converts the second access request into a third access request conforming to the first communication protocol and outputs the third access request, and a second device outputs data, based on the third access request, wherein the first relay device receives the data via the second relay device and holds the data, after which the first relay device receives a fourth access request from the first device and outputs the data held therein to the first device.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an embodiment of an information processing device and a method of controlling the information processing device;

FIG. 2 illustrates another embodiment of an information processing device and a method of controlling the information processing device;

FIG. 3 illustrates an exemplary printed circuit board provided in a slot formed in the server;

FIG. 4 illustrates exemplary specifications for the timings of a read operation and a write operation using an IC2 bus;

FIG. 5 illustrates a diagram of an exemplary sequence of measuring a response time between a card and an expansion device as illustrated in FIG. 2;

FIG. 6 illustrates a diagram of another exemplary sequence of measuring a response time between a card and an expansion device as illustrated in FIG. 2;

FIG. 7 illustrates exemplary information that the CPU mounted on the card sends to the service processor in response to a read request, in the sequence diagrams of FIGS. 5 and 6;

FIG. 8 illustrates exemplary allocation of caches to the RAM mounted on a card as illustrated in FIG. 2;

FIG. 9 illustrates a diagram of an exemplary sequence of reading data from an I2C device in an expansion device as illustrated in FIG. 2;

FIG. 10 illustrates a diagram of another exemplary sequence of reading data from an I2C device in an expansion device as illustrated in FIG. 2;

FIG. 11 illustrates an information flow in the sequence diagram of FIG. 9.

FIG. 12 illustrates a diagram of an exemplary sequence of writing data to the I2C device in the expansion device illustrated in FIG. 2;

FIG. 13 illustrates exemplary formats of a read request command, a write request command, and a communication check command in FIGS. 9, 12, and 5, respectively;

FIG. 14 illustrates exemplary formats of a read data send command and a communication response command in FIGS. 9 and 5, respectively;

FIG. 15 is a flowchart of an exemplary read process performed by the service processor illustrated in FIG. 2;

FIG. 16 is a flowchart of an exemplary operation of a CPU mounted on a card as illustrated in FIG. 2; and

FIG. 17 is a flowchart of an exemplary operation of the CPU 1 mounted in the expansion device illustrated in FIG. 2.

### DESCRIPTION OF EMBODIMENTS

To give an example, in order to operate a master and a slave in conformity with an I2C protocol, they are preferably positioned within a distance that satisfies the specifications for the timing of the I2C bus. If they are placed apart beyond the above distance, an access operation using the I2C protocol may cause a malfunction. To give another example, a first device has a first master but a second slave is mounted in a second device together with a second master, because the first device does not allow for the placement of the second slave. In addition, the first and second masters are coupled to each other by a bus that conforms to a protocol different from the I2C bus protocol. In this case, the first master accesses the first slave mounted in the same device and the second slave in the other device by using different protocols. As a result, access control is complicated.

Hereinafter, an information processing device and a method of controlling the information processing device enable the first device to receive data from the second device via the first communication line even when a first device and a second device are placed apart at a distance that does not satisfy specifications for the timing of a first communication line.

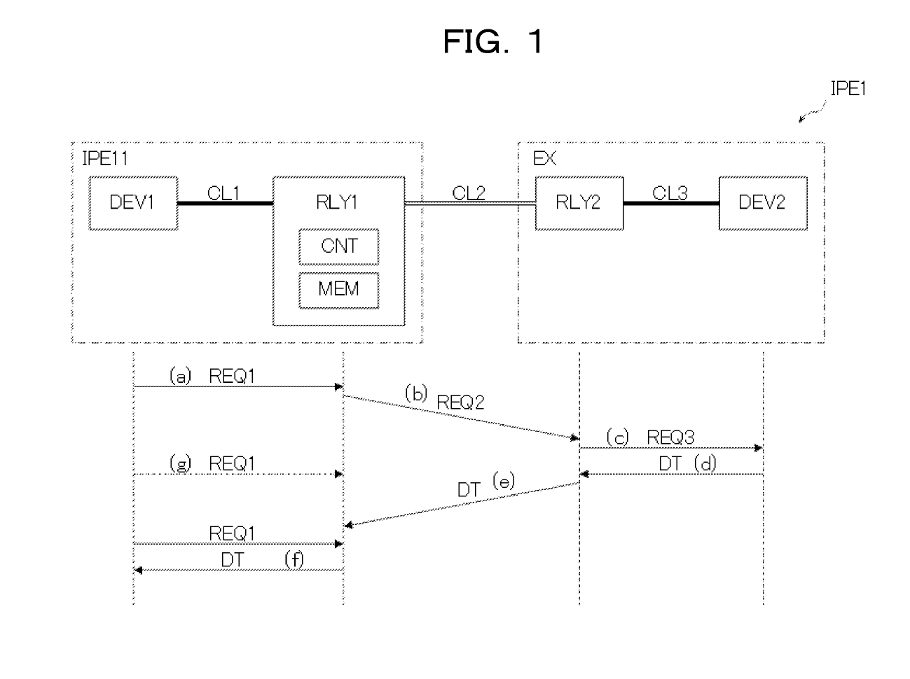

FIG. 1 illustrates an embodiment of an information processing device and a method of controlling the information processing device. As illustrated in FIG. 1, an information processing device IPE1 includes a first device DEV1, a first relay device RLY1, a second relay device RLY2, and a second device DEV2. The first relay device RLY1 has a memory section MEM and a control section CNT. The memory section MEM holds data DT read from the second device DEV2; the control section CNT controls the operation of the first relay device RLY1 and the output of the data DT held in the memory section MEM to the first device DEV1.

The first device DEV1 and the first relay device RLY1 are coupled to each other by a first communication line CL1. The first relay device RLY1 and the second relay device RLY2 are coupled to each other by a second communication line CL2 that is independent of the first communication line CL1. The second relay device RLY2 and the second device DEV2 are coupled to each other by a third communication line CL3 that conforms to the same protocol as the first communication line CL1. For example, both the first device DEV1 and the first relay device RLY1 are mounted in a first information processing device IPE11; both the second relay device RLY2 and the second device DEV2 are mounted in an expansion device EX for the first information processing device IPE11.

The first relay device RLY1 performs two-way conversion of the protocols for the first communication line CL1 and the second communication line CL2. The second relay device RLY2 performs two-way conversion of the protocols for the second communication line CL2 and the third communication line CL3.

If the second device DEV2 is coupled directly to the first communication line CL1, for example, it could be accessible by the first information processing device IPE11. The first information processing device IPE11 in FIG. 1, however, does not allow for the placement of the second device DEV2. For this reason, the second device DEV2 is mounted in the expansion device EX and coupled to the first device DEV1 via both the first relay device RLY1 and the second relay device RLY2. In short, the expansion device EX is provided in order to install the second device DEV2 and coupled to the first information processing device IPE11 via the second communication line CL2.

A description will be given below regarding an exemplary case in which the first device DEV1 accesses the second device DEV2 and reads data therefrom.

First, in order to read the data DT from the second device DEV2, the first device DEV1 outputs a first access request REQ1 to the first communication line CL1 ((a) in FIG. 1). When the first relay device RLY1 receives the first access request REQ1 via the first communication line CL1, it converts the first access request REQ1 into a second access request REQ2 conforming to the protocol for the second communication line CL2 and then outputs the second access request REQ2 to the second communication line CL2 ((b) in FIG. 1). When the second relay device RLY2 receives the second access request REQ2 via the second communication line CL2, it converts the second access request REQ2 into a third access request REQ3 conforming to the protocol for the first communication line CL1 and then outputs the third access request REQ3 to the third communication line CL3 ((c) in FIG. 1).

The second device DEV2 operates in accordance with the third access request REQ3 and outputs the data DT to the third communication line CL3 ((d) in FIG. 1). When the second relay device RLY2 receives the data DT from the second device DEV2, it converts the data DT into those conforming to the protocol for the second communication line CL2 and then outputs the converted data DT to the second communication line CL2 ((e) in FIG. 1). Assuming that the first relay device RLY1 outputs the data DT received via the second communication line CL2 to the first communication line CL1, the output timing of the data DT does not satisfy the specifications for the timing of the first communication line CL1 relative to the first access request REQ1. If the first device DEV1 receives data in response to the first access request REQ1, for example, it recognizes the received data to be incorrect.

In order for the first device DEV1 to receive correct data, the first relay device RLY1 holds the data DT received via the second communication line CL2 in the memory section MEM without outputting it in response to the first access request REQ1.

For example, the data DT received via the second communication line CL2 are written to the memory section MEM under the control of the control section CNT. When the control section CNT receives a new first access request REQ1 from the first device DEV1 while holding the data DT in the memory section MEM, it outputs the data DT from the memory section MEM to the first device DEV1 ((f) in FIG. 1). Since the control section CNT outputs the data DT in response to the new first access request REQ1, the output timing of the data DT satisfies the specifications for the timing of the first communication line CL1. In this way, the data DT are read from the second device DEV2 in response to a first access request REQ1 and then received by the first device DEV1 in response to a following first access request REQ1. Alternatively, the first relay device RLY1 may output invalid information to the first device DEV1 in response to the earliest first access request REQ1. Furthermore, when the first relay device RLY1 receives a first access request REQ1 before holding the data DT in the memory section MEM, for example, it makes this first access request REQ1 invalid ((g) in FIG. 1).

According to the embodiment described with reference to FIG. 1, first the data DT are read from the second device DEV2 in response to a first access request REQ1 and are then outputted to the first device DEV1 in response to a following first access request REQ1. Therefore, the timing at which the first relay device RLY1 outputs the data DT to the first device DEV1 satisfies the specifications for the timing of the first communication line CL1 relative to the following first access request REQ1.

For example, suppose the first device DEV1 repeatedly outputs first access requests REQ1. First, in response to the first one of the first access requests REQ1, the first relay device RLY1 outputs a second access request REQ2 for accessing the second device DEV2 to the second relay device RLY2. Then, in response to one of the first access requests REQ1 which has been received after the reception of data DT from the second device DEV, the first relay device RLY1 outputs the data DT to the first device DEV1. In this case, the first relay device RLY1 outputs a second access request REQ2 and the data DT to the second relay device RLY2 and the first device DEV1, respectively, in response to first access requests REQ1 received at different timings. This enables the first device DEV1 to receive the data DT from the second device DEV2 in conformity with the specifications for the timing of the first communication line CL1.

In other words, this embodiment enables the first device DEV1 to receive correct data DT even if the timing at which the first relay device RLY1 outputs the data DT to the first device DEV1 does not satisfy the specifications for the timing of the first communication line CL1 relative to the first one of the first access requests REQ1. Consequently, even if the first device DEV1 and the second device DEV2 are separated by a distance that does not satisfy the specifications for the timing of the first communication line CL1, it is possible for the first device DEV1 to receive the data DT from the second device DEV2 via the first communication line CL1.

The first device DEV1 and the second device DEV2 are coupled to the first communication line CL1 and the third communication line CL3, respectively, both of which conform to the same protocol. Therefore, even if the first device DEV1 and the second device DEV2 are positioned considerably apart from each other, the first device DEV1 successfully accesses the second device DEV2 in conformity with the specifications for the timing of the first communication line CL1. Thus, the first device DEV1 and the second device DEV2 do not have to undergo redesign.

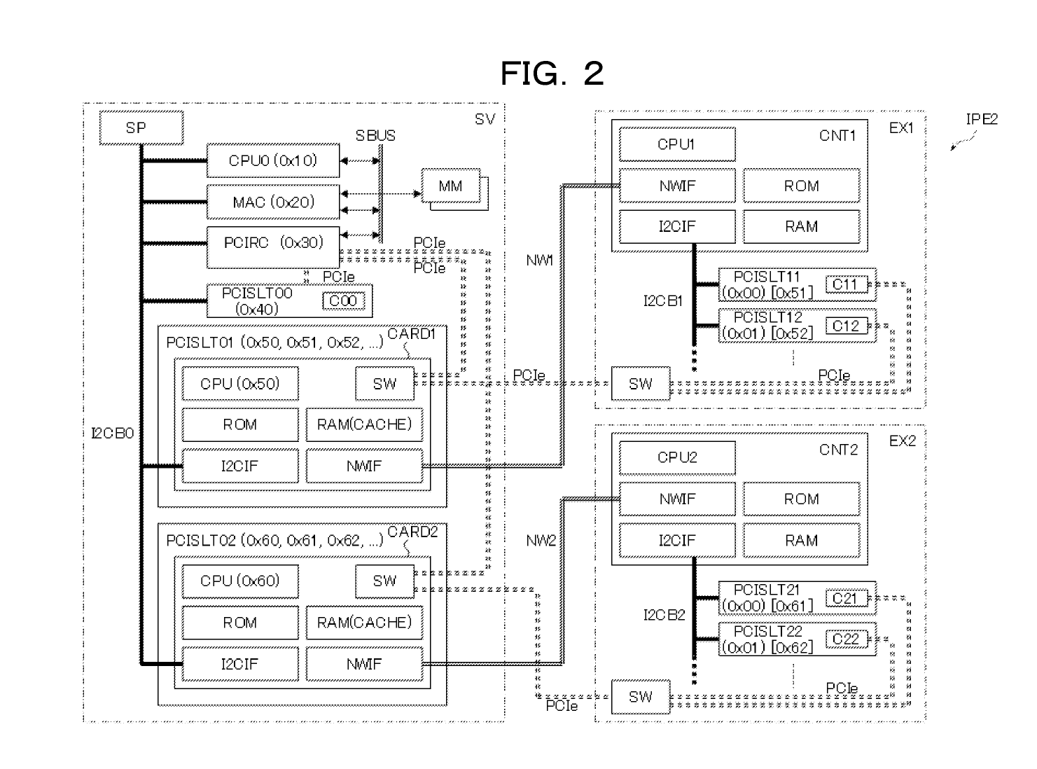

FIG. 2 illustrates another embodiment of an information processing device and a method of controlling the information processing device. Constituent elements that are substantially the same as in the embodiment illustrated in FIG. 1 are denoted by the same reference characters and will not be described. An information processing device IPE2 in this embodiment includes: a server SV; and expansion devices EX1 and EX2 coupled to the server SV via networks NW1 and NW2, respectively. The server SV corresponds to an exemplary first information processing device; each of the expansion devices EX1 and EX2 corresponds to an exemplary second information processing device.

The server SV includes a service processor SP, a central processing unit (CPU) 0, a memory access controller MAC, a memory module MM, and a root complex PCIRC. Furthermore, the server SV includes slots PCISLT00, PCISLT01, and PCISLT02 to which cards C00, CARD1, and CARD2 are attached, respectively. The service processor SP corresponds to an exemplary first device; each of the cards CARD1 and CARD2 corresponds to an exemplary first relay device.

For example, each of the slots PCISLT00, PCISLT01, and PCISLT02 is a connector specified in the specifications for peripheral component interconnect (PCI) express (trademark). Hereinafter, the PCI express will be referred to as PCIe; a bus specified in the PCIe specifications will be referred to as a bus PCIe.

Each of the CPU 0, the memory access controller MAC, the root complex PCIRC, and the cards C00, CARD1 and CARD2 has an interface conforming to the I2C specifications. Each of the root complex PCIRC and the cards C00, CARD1, and CARD2 has an interface conforming to the PCIe specifications.

The service processor SP is coupled to the CPU 0, the memory access controller MAC, the root complex PCIRC, and the slots PCISLT00, PCISLT01 and PCISLT02 via a bus I2CB0. The bus I2CB0 is implemented, for example, using an I2C bus specified in the I2C specifications, and corresponds to an exemplary first communication line.

The service processor SP monitors and controls the CPU 0, the memory access controller MAC, the root complex PCIRC, and the cards C00, CARD1 and CARD2 in the server SV, to which the service processor SP is coupled via the bus I2CB0. In addition, the service processor SP monitors and controls cards C11 and C12 mounted in the expansion device EX1 and cards C21 and C22 mounted in the expansion device EX2, via networks NW1 and NW2, respectively.

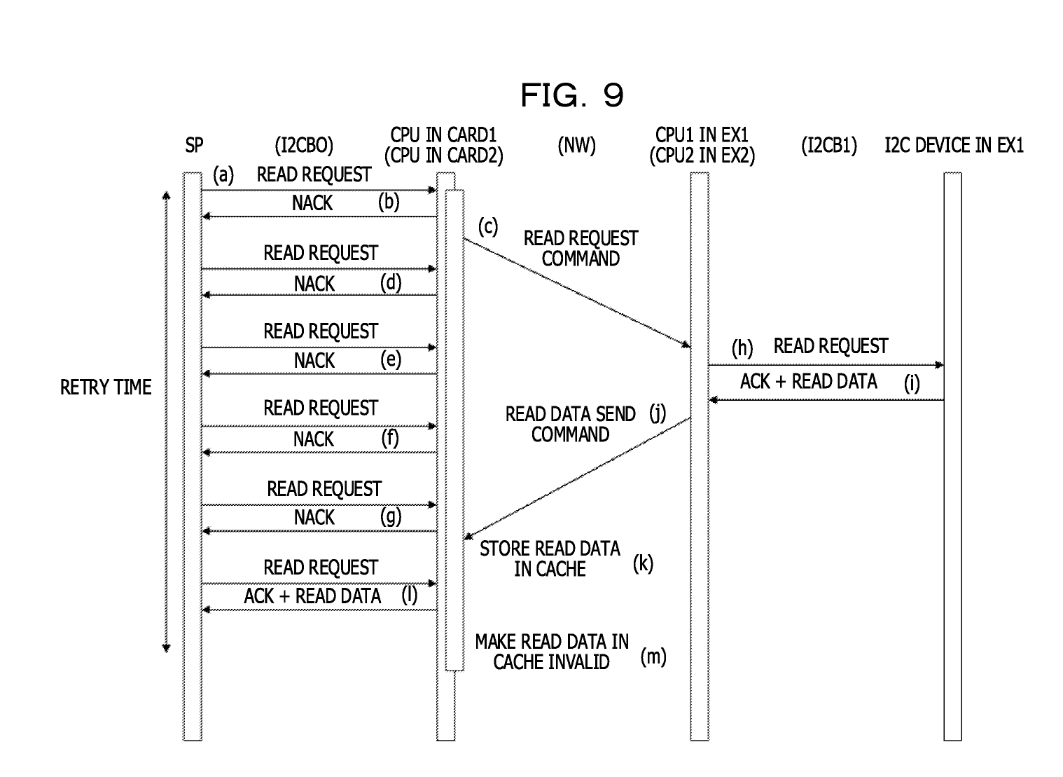

Each of the cards C11 and C12 serves as an I2C device coupled to the network NW1 via a bus I2CB1 specified in the I2C specifications. Each of the cards C21 and C22 serves as an I2C device coupled to the network NW2 via a bus I2CB2 specified in the I2C specifications. In addition, each of the cards C11, C12, C21, and C22 also serves as a PCIe device that is accessible by the CPU 0 via the bus PCIe. Access to the cards C11, C12 C21, and C22 from the service processor SP via the bus I2CB0 will be described later with reference to FIG. 9.

The CPU 0, the memory access controller MAC, and the root complex PCIRC are coupled to a system bus SBUS. The memory access controller MAC accesses the memory module MM in accordance with an instruction from the CPU 0. For example, the CPU 0 executes programs stored in the memory module MM, fulfilling the functions of the server SV. The root complex PCIRC couples the system bus SBUS to the bus PCIe, permitting the CPU 0 to access the cards C00, CARD1, and CARD2.

The card CARD1 is attached to the slot PCISLT01 when the slots PCISLT11 and PCISLT12 in the expansion device EX1 are installed. The card CARD2 is attached to the slot PCISLT01 when the slots PCISLT21 and PCISLT22 in the expansion device EX2 are installed. In short, when there is a shortage of slots used to install a device having a PCIe interface, the card CARD1 is attached to the slot PCISLT01 or the card CARD2 is attached to the slot PCISLT02.

The card CARD1 includes a CPU, a read only memory (ROM), a random access memory (RAM), interfaces I2CIF and NWIF, and a switch SW. The CPU corresponds to an exemplary control section, and has a function of controlling communication between the service processor SP and an I2C device mounted in the expansion device EX1. For example, the ROM stores programs to be executed by the CPU; the RAM holds data to be handled by the CPU and temporarily holds data outputted from an I2C device such as the card C11 or C12 mounted in the expansion device EX1. Thus, the RAM functions as a cache that temporarily holds data outputted from an I2C device mounted in the expansion device EX1. This cache corresponds to an exemplary storage section.

The interface I2CIF couples the card CARD1 to the bus I2CB0 and allows the exchange of data between the card CARD1 and the service processor SP. The interface NWIF couples the card CARD1 to the network NW1 and allows the exchange of data between the card CARD1 and the expansion device EX1. For example, each of the networks NW1 and NW2 is implemented using a LAN; the interface NWIF is implemented using a LAN interface. Each of the networks NW1 and NW2 corresponds to an exemplary second communication line.

The switch SW mounted on the card CARD1 operates in conformity with the PCIe specifications and couples the bus PCIe in the server SV to the expansion device EX1. Likewise, the switch SW mounted on the card CARD2 operates in conformity with the PCIe specifications and couples the bus PCIe in the server SV to the expansion device EX2.

The card CARD2 has substantially the same configuration as the card CARD1. Since the functions of the cards CARD1 and CARD2 are substantially the same as each other, except for the expansion devices (EX1 and EX2) to which they are coupled, details of the card CARD2 will not be described.

The expansion device EX1 includes: a control device CNT1; slots PCISLT11 and PCISLT12 to which the cards C11 and C12, respectively, are attached; and a switch SW. The expansion device EX2 includes: a control device CNT2; slots PCISLT21 and PCISLT22 to which the cards C21 and C22, respectively, are attached; and a switch SW. Each of the cards C11, C12, C21, and C22 has interfaces conforming to both the I2C and PCIe specifications. Each of the cards C11, C12, C21, and C22 corresponds to an exemplary second device.

The CPU 0, the memory access controller MAC, the root complex PCIRC, and the slot PCISLT00 are assigned addresses 0x10, 0x20, 0x30, and 0x40, respectively, for access using the bus I2CB0. Note that the “0x” of the address “0x10” or the like indicates hexadecimal notation.

Each of the slots PCISLT01 and PCISLT02 are assigned a plurality of addresses (0x50, 0x51, 0x52, and so on or 0x60, 0x61, 0x62, and so on) for access using the bus I2CB0.

The addresses “0x50”, “0x51”, and “0x52” correspond to those of a CPU mounted on the card CARD1 attached to the slot PCISLT01, the slot PCISLT11 in the expansion device EX1 to which the card CARD1 is coupled, and the slot PCISLT12 in the expansion device EX1, respectively.

The addresses “0x60”, “0x61”, and “0x62” corresponds to those of a CPU mounted on the card CARD2 attached to the slot PCISLT02, the slot PCISLT21 in the expansion device EX2 to which the card CARD2 is coupled, and the slot PCISLT22 in the expansion device EX2, respectively.

For example, when the service processor SP outputs an access request to the bus I2CB0 while specifying the address to “0x50”, this access request is handled as an access request for the CPU mounted on the card CARD1. When the service processor SP outputs an access request to the bus I2CB0 while specifying the address to “0x51”, this access request is handled as an access request for an I2C device (card C11) attached to the slot PCISLT11.

The control device CNT1 includes a CPU 1, a ROM, a RAM, and interfaces NWIF and I2CIF; the control device CNT2 includes a CPU 2, a ROM, a RAM, and interfaces NWIF and I2CIF. The control devices CNT1 and CNT2 have substantially the same function as each other, except for cards (CARD1 and CARD2) coupled thereto and I2C devices mounted therein. Accordingly, only the control device CNT1 will be described below.

The CPU 1 controls the communication between the card CARD1 and the I2C device mounted in the expansion device EX1. For example, the ROM stores programs to be executed by the CPU 1; the RAM holds data to be handled by the CPU 1.

The interface I2CIF is coupled to the slots PCISLT11 and PCISLT12 via the bus I2CB1 and sends/receives data to or from the cards C11 and C12 attached to the slots PCISLT11 and PCISLT12, respectively. Each of the buses I2CB1 and I2CB2 is implemented, for example, using an I2C bus specified in the I2C specifications and corresponds to an exemplary third communication line.

The interface NWIF is implemented, for example, using a LAN interface, and is coupled to the card CARD1 via the network NW1 and mediates data between the expansion device EX1 and the card CARD1. The slots PCISLT11 and PCISLT12 in the expansion device EX1 are assigned addresses (0x00 and 0x01) for access to the expansion device EX1 using the bus I2CB1. The slots PCISLT21 and PCISLT22 in the expansion device EX2 are assigned addresses (0x00 and 0x01) for access to the expansion device EX2 using the bus I2CB2.

The switch SW in the expansion device EX1 couples the switch SW in the card CARD1 to the cards C11 and C12 attached to the slots PCISLT11 and PCISLT12, respectively. Likewise, the switch SW in the expansion device EX2 couples the switch SW in the card CARD2 to the cards C21 and C22 attached to the slots PCISLT21 and PCISLT22, respectively.

Note that buses for a serial peripheral interface (SPI (trademark)) may be used instead of buses I2CB0, I2CB1, and I2CB2.

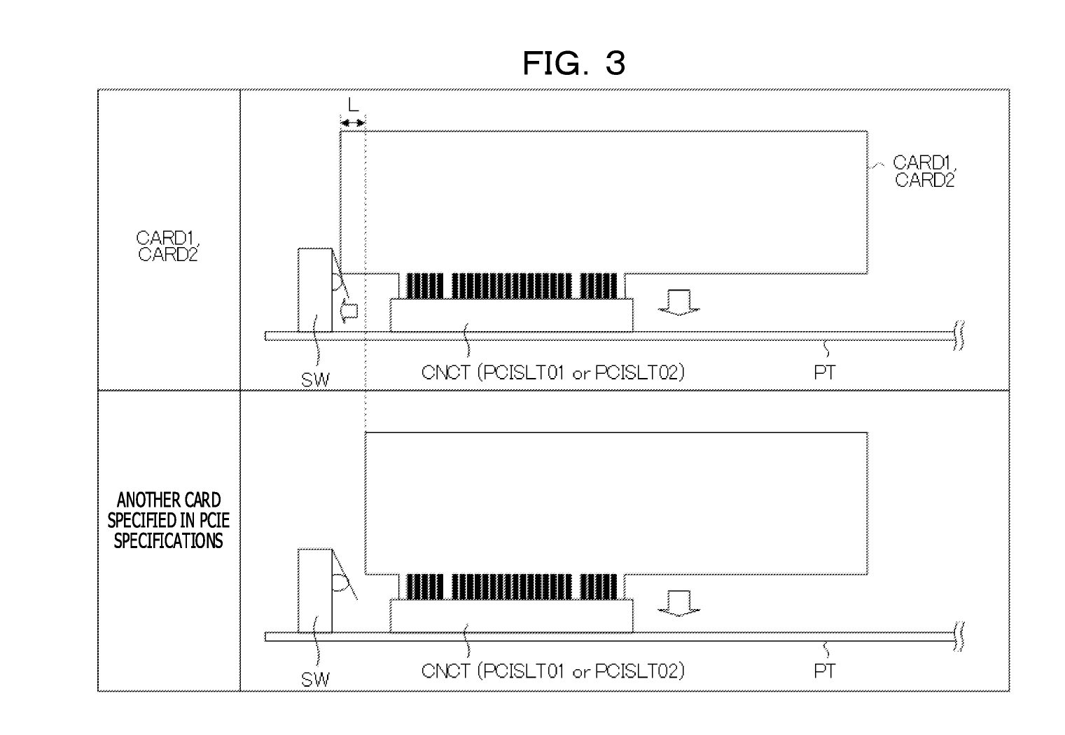

FIG. 3 illustrates an exemplary printed circuit board PT provided in the server SV on which the slot PCISLT01 or PCISLT02 is mounted. A connector CNCT and a push switch SW are mounted on the printed circuit board PT. The connector CNCT corresponds to either of the slots PCISLT01 and PCISLT02. Note that the card CARD1, CARD2 or some other card specified in the PCIe specifications may be attached to the slots PCISLT01 and PCISLT02.

The cards CARD1 and CARD2 are designed to protrude toward the push switch SW by a length L, unlike other cards that conform to the PCIe specifications. As illustrated in the upper part of FIG. 3, when the card CARD1 is attached to the slot PCISLT01 or the card CARD2 is attached to the slot PCISLT02, the push switch SW is depressed. In contrast, as illustrated in the lower part of FIG. 3, when another card (for example, the cards C00, C11, C12, C21, and C22 in FIG. 2) that conforms to the PCIe specifications is attached to the slot PCISLT01 or PCISLT02, the push switch SW is not depressed. The push switch SW corresponds to an exemplary detecting section that detects the contact with the card CARD1 or CARD2 attached to the connector CNCT.

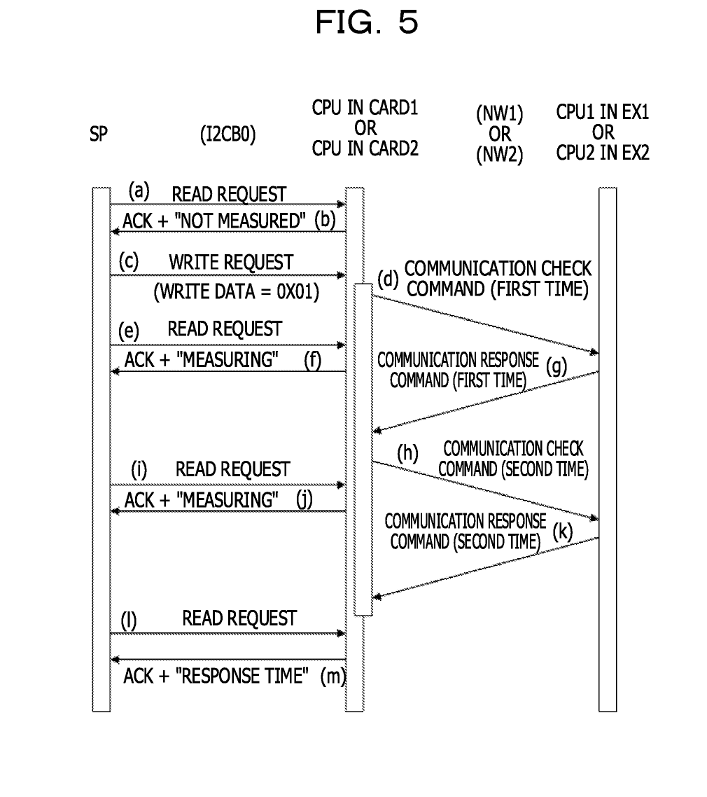

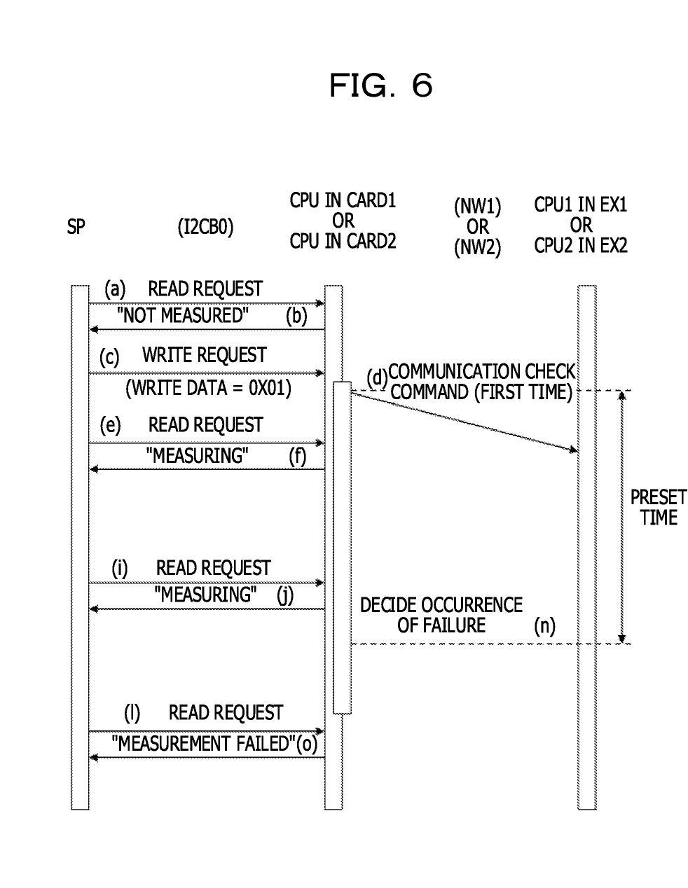

The service processor SP monitors the electrical states of push switches SW to detect the attaching of the cards CARD1 and CARD2 to the slots PCISLT01 and PCISLT02, respectively. In other words, the service processor SP detects the coupling between the server SV and each of the expansion devices EX1 and EX2. For example, when the information processing device IPE2 is started up, the service processor SP monitors the states of the push switches SW, detecting whether or not the cards CARD1 and CARD2 are attached to the slots PCISLT01 and PCISLT02, respectively. Then, when the service processor SP detects the attaching of the card CARD1 or CARD2, it performs a response time measuring process, for example, in a power sequence. Details of this process will be described below with reference to FIGS. 5 and 6. When another card that conforms to the PCIe specifications is attached to the slot PCISLT01 or PCISLT02, the service processor SP does not perform the above response time measuring process.

Providing the above push switches SW that detect the attaching of the cards CARD1 and CARD2 to the slots PCISLT01 and PCISLT02, respectively, on the printed circuit board PT in the server SV makes it possible to detect the installation of the expansion devices EX1 and EX2. Then, when the service processor SP detects the installation of the expansion device EX1 or EX2, it determines a response time and a retry time for the expansion device EX1 or EX2. Details of the retry time will be described later with reference to FIG. 5. The connector CNCT may also enable the slot PCISLT01 or PCISLT02 to be used, for example, as another slot to which a PCIe card is attached.

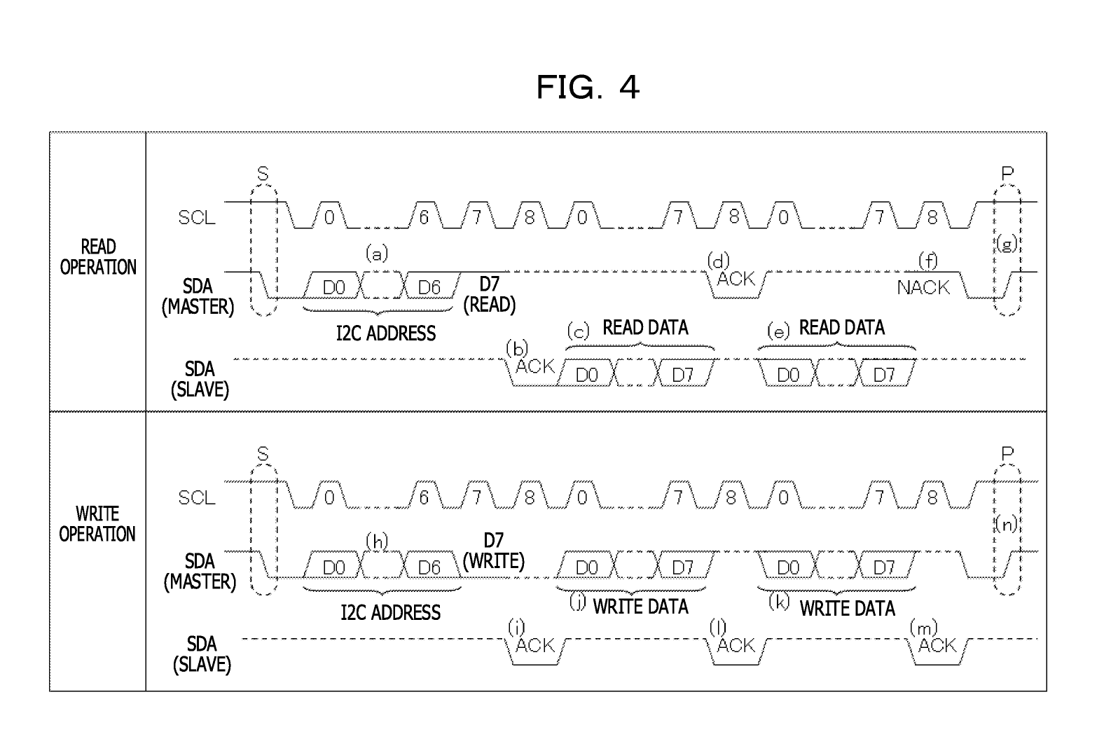

FIG. 4 illustrates exemplary specifications for read and write operations using an IC2 bus. A clock SCL is output from a master; data SDA are output from the master or a slave. The data SDA transit during the low level of the clock SCL. When the master starts a read or write operation, it changes the data SDA from a high level to a low level while the clock SCL is on a high level (start command S; start condition). When the master terminates the read or write operation, it changes the data SDA from a low level to a high level while the clock SCL is at a high level (stop command P; stop condition).

For example, the master corresponds to the service processor SP as illustrated in FIG. 2; the slave corresponds to one of the CPU 0, the memory access controller MAC, the root complex PCIRC, and the CPUs mounted on the cards C00, CARD1 and CARD2 as illustrated in FIG. 2. Alternatively, the master corresponds to the CPU 1 mounted in the expansion device EX1; the slave corresponds to the cards C11 and C12, or the master corresponds to the CPU 2 mounted in the expansion device EX2; the slave corresponds to the cards C21 and C22.

In the read operation, after outputting the start command S, the master outputs a read request made up of 8-bit data D0-D7, which synchronizes the clock SCL, to the I2C bus as the data SDA ((a) in FIG. 4). The bit-data D0-D6 represent the I2C address assigned to an I2C device from which data will be read; the bit D7 (high level) represents a read request.

In response to the read request, the I2C device that is assigned the I2C address contained in this read request outputs a low-level ACK to the I2C bus ((b) in FIG. 4). Subsequent to the ACK, the I2C device further outputs 1-byte read data D0-D7 to the I2C bus ((c) in FIG. 4). The master receives the ACK and the read data D0-D7 via the IC2 bus. When the master does not receive all the read data, it outputs an ACK to the I2C bus ((d) in FIG. 4). In response to this ACK, the I2C device outputs next read data D0-D7 to the I2C bus ((e) in FIG. 4). When the master receives all the read data, it outputs a high-level NACK to the I2C bus ((f) in FIG. 4). Based on this NACK, the I2C device recognizes that the read operation has completed. After outputting the NACK, the master outputs the stop command P to the I2C bus, so that the read operation is terminated ((g) in FIG. 4).

In the write operation, after outputting the start command S, the master outputs a write request made up of 8-bit data D0-D7, which synchronizes the clock SCL, to the I2C bus as the data SDA ((h) in FIG. 4). The bit-data D0-D6 represent the I2C address assigned to an I2C device to which data will be written; the bit D7 (low level) represents a write request.

In response to the write request, the I2C device that is assigned the I2C address contained in this write request outputs a low-level ACK to the I2C bus ((i) in FIG. 4). In response to this ACK, the master outputs 1-byte write data D0-D7 to the I2C bus ((j) and (k) in FIG. 4). The I2C device receives the write data D0-D7 and then outputs an ACK to the I2C bus ((l) and (m) in FIG. 4). After outputting all the write data, the master outputs a stop command P to the I2C bus in response to the ACK from the I2C device, so that the write operation is terminated ((n) in FIG. 4).

FIG. 5 illustrates a diagram of an exemplary sequence of measuring a response time between the card CARD1 and the expansion device EX1, as illustrated in FIG. 2. Suppose the response time is measured by the card CARD1 in accordance with an instruction from the service processor SP in a power sequence of the information processing device IPE2.

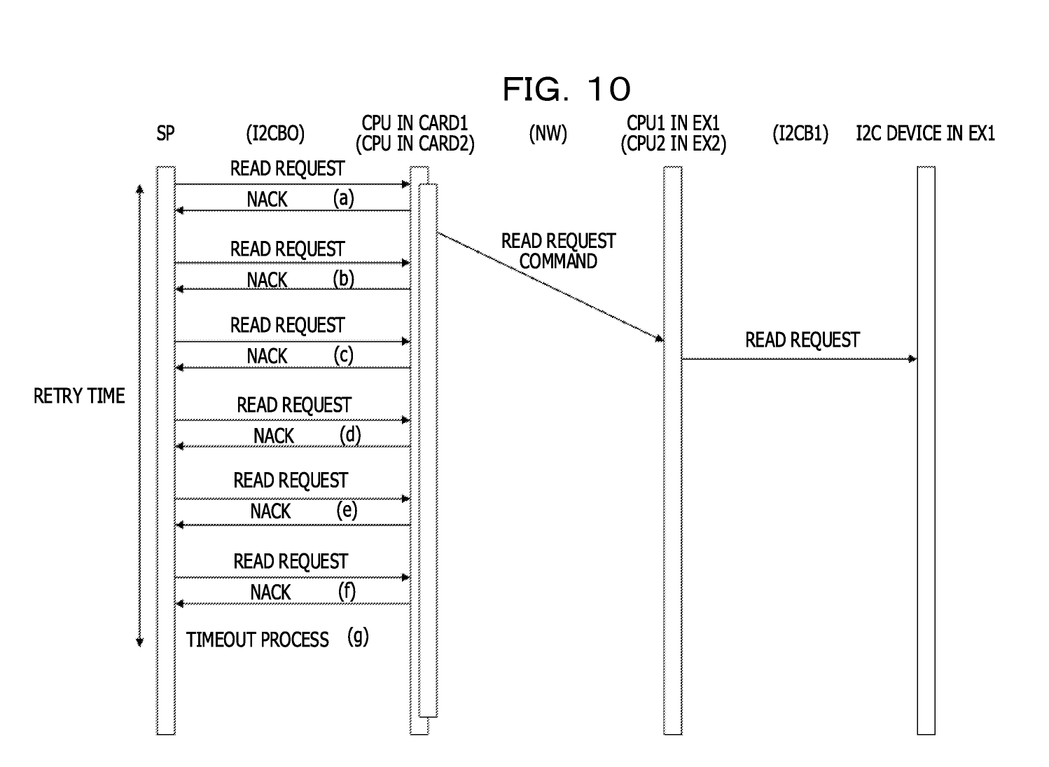

The response time between the card CARD1 and the expansion device EX1 depends on the distance between the server SV and the expansion device EX1 (the length of the cable of the network NW1), the clock frequency of the expansion device EX1, and the like. Likewise, the response time between the card CARD2 and the expansion device EX2 depends on the distance between the server SV and the expansion device EX2 (the length of the cable of the network NW2), the clock frequency of the expansion device EX2, and the like. For this reason, the response time is preferably determined through actual measurement. For example, the service processor SP sets a retry time, as depicted in FIGS. 9 and 10, based on a measurement of the response time, and decides whether or not a timeout has occurred when accessing an I2C device in the expansion device EX1.

The response time between the card CARD2 and the expansion device EX2 is measured by the same method as that depicted in FIG. 5, except that the service processor SP sends a read request to the card CARD2. For this reason, the sequence of measuring the response time between the card CARD1 and the expansion device EX1 will be described below, and the sequence of measuring the response time between the card CARD2 and the expansion device EX2 will not be described.

First, the service processor SP outputs a read request for the CPU (I2C address=0x50) mounted on the card CARD1 to the bus I2CB0 ((a) in FIG. 5). Then, the CPU recognizes that this read request is directed to the CPU itself, based on the I2C address (0x50) contained therein. In this case, the read request sent from the service processor SP to the CPU is used as a monitor request to monitor the measuring state of the response time, and corresponds to an exemplary third command. Since the CPU has not started measuring the response time when receiving the first read request, it sends information “not measured” and an ACK to the service processor SP ((b) in FIG. 5).

The service processor SP recognizes that the CPU has not measured the response time by receiving the information “not measured” and then sends a write request made up of data 0x01 to the CPU via the bus I2CB0 ((c) in FIG. 5). This write request for the CPU corresponds to an exemplary first command for use in giving an instruction for measuring the response time in the communication between the card CARD1 and the expansion device EX1.

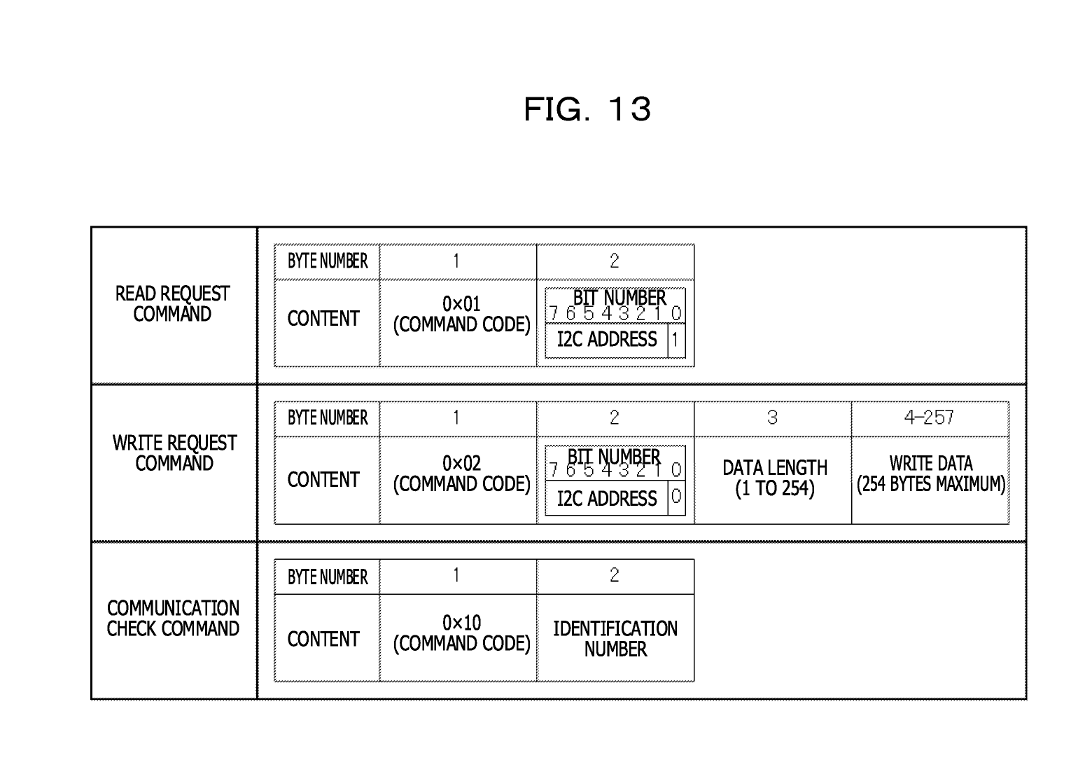

The CPU recognizes the write request to write the data 0x01 as a command for starting the measurement of the response time. Then, the CPU sends a communication check command to the CPU 1 mounted in the expansion device EX1 via the network NW1 ((d) in FIG. 5). The communication check command corresponds to an exemplary second command for use in checking the state of the communication with the expansion device EX1. The CPU mounted on the card CARD1 stores the send time of the communication check command and the identification number contained in the communication check command in the RAM or in a built-in register. An exemplary format of this communication check command is illustrated in FIG. 13.

After sending a measurement start command, the service processor SP sends a read request (a request to monitor the measuring state of the response time) to the CPU via the bus I2CB0 ((e) in FIG. 5). At this time, the CPU is in the middle of measuring the response time and accordingly sends information “measuring” to the service processor SP via the bus I2CB0 ((f) in FIG. 5).

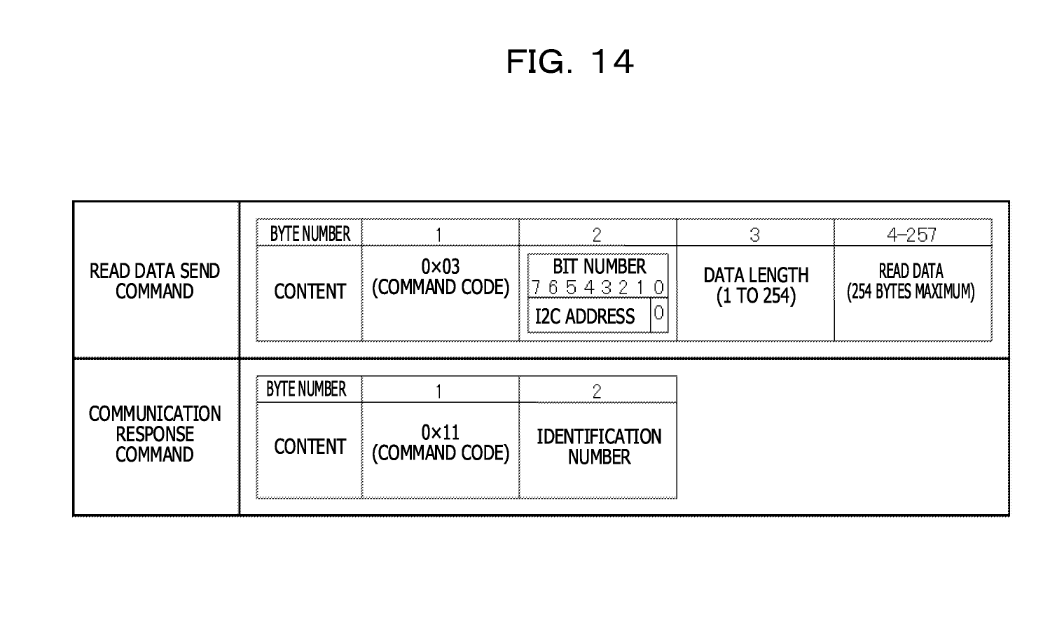

In response to the communication check command, the CPU 1 mounted in the expansion device EX1 sends a communication response command containing the identification number, which has been received together with the communication check command, to the CPU mounted on the card CARD1 via the network NW1 ((g) in FIG. 5). An exemplary format of the communication response command is illustrated in FIG. 14. The CPU stores a time of receiving the communication response command and the received identification number, in the RAM and the built-in register.

In this exemplary sequence, the CPU sends communication check commands twice, and measures twice the response times from the CPU 1 mounted in the expansion device EX1. More specifically, after receiving the communication response command, the CPU sends a second communication check command to the CPU 1 via the network NW1 ((h) in FIG. 5). The CPU stores the send time of the second communication check command and the identification number for use in identifying the second communication check command in the RAM or in the built-in register. Note that the identification numbers differ from one communication check command to another; the CPU mounted on the card CARD1 may send the communication check command once or more than twice.

After a lapse of a preset time interval, the service processor SP sends a read request (a request to monitor the measuring state of the response time) to the CPU via the bus I2CB0 ((i) in FIG. 5). At this time, the CPU is in the middle of measuring the response time and accordingly sends information “measuring” to the service processor SP via the bus I2CB0 ((j) in FIG. 5).

In response to the second communication check command, the CPU 1 sends a communication response command that contains the identification number that has been received together with the second communication check command to the CPU via the network NW1 ((k) in FIG. 5). The CPU stores the reception time of the second communication response command and the received identification number in the RAM or in the built-in register.

The CPU accesses the RAM or the built-in register to search for some pairs of a send time and a reception time corresponding to the same identification number. Then, the CPU determines the differences therebetween as response times. The response times are determined in relation to respective identification numbers and are each defined as a time period over which the CPU outputs a communication check command to the expansion device EX1 and then receives a communication response command therefrom.

If the CPU does not receive a communication response command, for example, due to an occurrence of a temporary failure in the network NW1, no pairs of a send time and a reception time corresponding to the same identification number are found. When the CPU receives no communication response commands, it may resend a communication check command with a unique identification number.

For example, the CPU may select the longest of the determined response times. Alternatively, the CPU may set the average of the determined response times to the response time to be output to the service processor SP. For example, if the CPU sends a communication check command to the CPU 1 only once, the CPU may determine the response time and employ it.

After a lapse of a preset time interval, the service processor SP sends a read request (a request to monitor a measuring state of the response time) to the CPU via the bus I2CB0 ((l) in FIG. 5). At this time, the response time has already been measured, and the CPU accordingly sends information indicating the selected response time (for example, the maximum value) to the service processor SP via the bus I2CB0 ((m) in FIG. 5).

The service processor SP adds the response time (for example, maximum value) of the I2C device in the expansion device EX1 to the response time received from the CPU and determines it as the retry time for the read request as depicted in FIGS. 9 and 10. For example, the maximum response time for the I2C device in the expansion device EX1 corresponds to a time period over which the CPU 1 sends a read request to the bus I2CB1 and then receives the final bit in the data having the maximum length from the I2C device. Note that the maximum response time of the I2C device depends on the clock frequency of the expansion device EX1 or EX2.

FIG. 6 illustrates another diagram of exemplary sequence of measuring a response time between the card CARD1 and the expansion device EX1, as illustrated in FIG. 2. Operations that are substantially the same as in FIG. 5 are denoted by the same reference characters and will not be described.

In the sequence in FIG. 6, after sending a communication check command to the CPU 1 mounted in the expansion device EX1, the CPU mounted on the card CARD1 does not receive a communication response command from the CPU 1 for a preset time. In this case, for example, the CPU decides that a failure has occurred in the communication path between the card CARD1 and the expansion device EX1 ((n) in FIG. 6).

When the CPU receives a read request (a request to monitor a measuring state of the response time) from the service processor SP after deciding the failure of the communication path, it sends information indicating “measurement failure” to the service processor SP via the bus I2CB0 ((o) in FIG. 6). The service processor SP decides that a failure has occurred in the communication path between the card CARD1 and the expansion device EX1 when receiving the information indicating “measurement failure”.

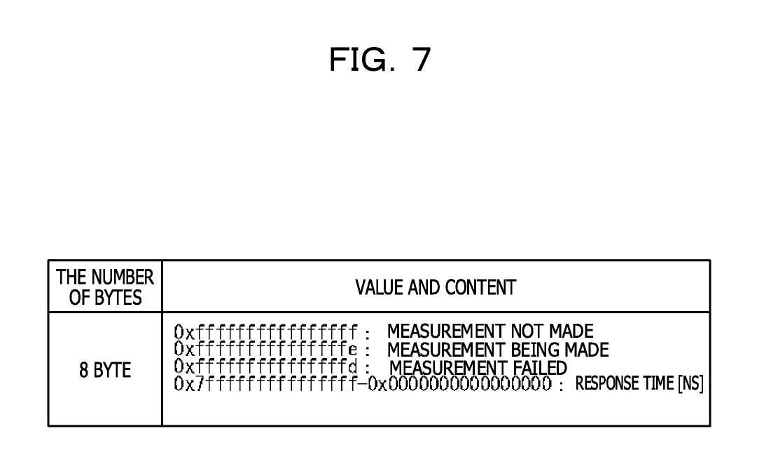

FIG. 7 illustrates exemplary information that the CPU mounted on the card CARD1 sends to the service processor SP in response to a read request (a request to monitor the measuring state of the response time) in the sequence diagram illustrated in FIG. 5 or 6. For example, the information responding to the read request may be expressed in the form of 8-bit data.

When the CPU has not measured a response time, it sends “0xffffffffffffffff” to the service processor SP, indicating that the measurement is not made. When the CPU is in the middle of measuring a response time, it sends “0xfffffffffffffffe” to the service processor SP, indicating that the measurement is being made. When the CPU fails to measure a response time, for example, due to an occurrence of a failure in the communication path between the card CARD1 and the expansion device EX1, it sends “0xfffffffffffffffd” to the service processor SP, indicating that the measurement failed. When the measurement of the response time is completed, the CPU sends one value in the range between “0x7fffffffffffffff” and “0x0000000000000000” which indicates the response time to the service processor SP. For example, the response time may be in the order of nanoseconds (ns).

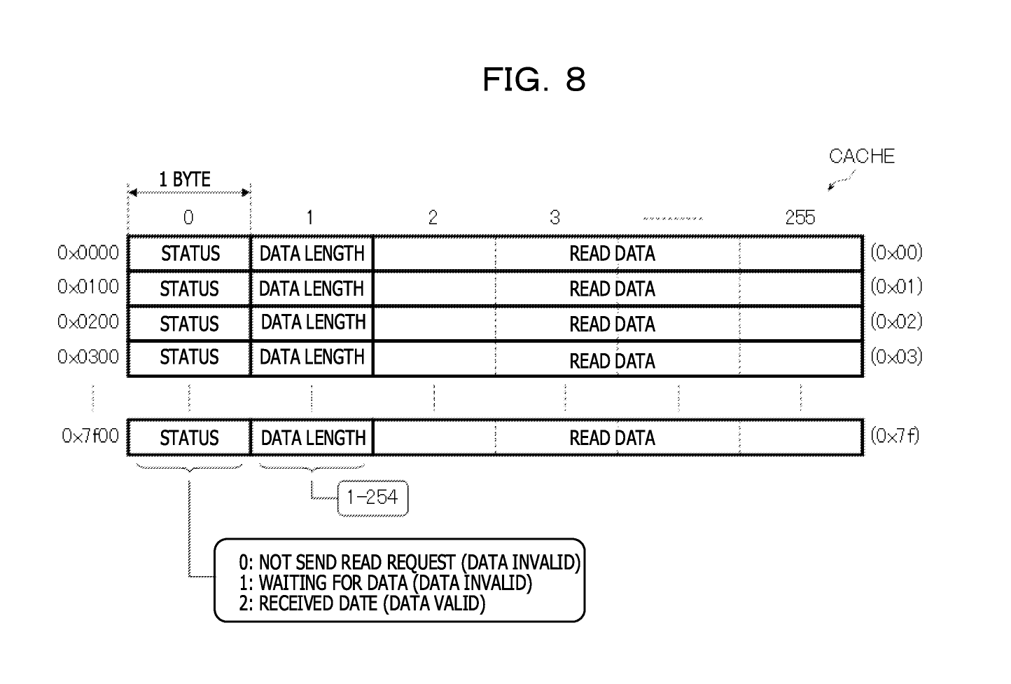

FIG. 8 illustrates exemplary allocation of caches CACHE to the RAM mounted on the card CARD1 in FIG. 2. Note that the allocation of caches CACHE to the RAM mounted on the card CARD2 in FIG. 2 is the same as that in FIG. 8.

The cache CACHE has a 256-byte storage region allocated to each of 128 I2C devices that are mountable in the expansion device EX1. For example, the initial addresses of the storage regions allocated to the 128 I2C devices are derived from the I2C addresses (0x00 to 0x7f) of the corresponding I2C devices (0x100 times the I2C addresses).

Each storage region is formed of: a 1-byte status region that stores a status; a 1-byte data-length region that stores a data length; and a 254-byte data region that stores read data. The value “0” in the status region indicates that the card CARD1 has not sent a read request to the expansion device EX1, that is, the data stored in the data region are invalid. The value “1” in the status region indicates that the card CARD1 has sent a read request to the expansion device EX1 and is waiting for data, that is, the data stored in the data region are invalid. The value “2” in the status region indicates that the card CARD1 has received data from the expansion device EX1, that is, the data stored in the data region is valid.

The data-length region holds the number of the bytes of valid data stored in the data region. The content of each cache CACHE is updated by the CPU mounted on the card CARD1, as will be described with reference to FIG. 9.

FIG. 9 is a sequence diagram of reading data from an I2C device in the expansion device EX1 illustrated in FIG. 2. Note that the sequence of reading data from an I2C device in the expansion device EX2 will not be described, because it is substantially the same as that in FIG. 9.

First, the service processor SP sends a read request to the CPU mounted on the card CARD1 via the bus I2CB0, in order to read data from an I2C device in the expansion device EX1 ((a) in FIG. 9). This read request corresponds to an exemplary first access request. The CPU checks that no valid data are stored in the storage region in the cache CACHE which is related to the I2C device from which the data will be read, and then sends a NACK to the service processor SP ((b) in FIG. 9). For example, when the CPU receives a read request for the I2C device (address 0x00) attached to the slot PCISLT11 as illustrated in FIG. 2, it checks the status of the cache CACHE which corresponds to the address “0x0000” as illustrated in FIG. 8.

Since no valid data are stored in the cache CACHE, the CPU sends a read request command to the CPU 1 mounted in the expansion device EX1 via the network NW1 ((c) in FIG. 9). This read request command corresponds to an exemplary second access request. After receiving the read request command, the CPU writes “1” (data waiting) to the status in the cache CACHE which is allocated for the I2C device, the destination of the read request command.

The service processor SP outputs read requests at fixed time intervals. In response to these read requests, the CPU sends NACKs to the service processor SP until it receives read data from the I2C device in the expansion device EX1 via the CPU 1 ((d), (e), (f), (g) in FIG. 9). Here, when the CPU receives a read request after setting the status in the cache CACHE to “data waiting”, it does not send a read request command in response to this read request.

The CPU 1 sends a read request to the I2C device via the bus I2CB1 in accordance with the read request command from the CPU ((h) in FIG. 9). The read request sent to the I2C device via the bus I2CB1 corresponds to an exemplary third access request. When the I2C device receives the read request, it sends an ACK and read data to the CPU 1 via the bus I2CB1 ((i) in FIG. 9). If the I2C device outputs multi-byte read data, it may repeatedly send multiple pieces of read data and the CPU 1 may repeatedly send ACKs, as illustrated in FIG. 4.

When the CPU 1 receives the read data from the I2C device, it sends the read data to the CPU via the network NW1 as a read data send command ((j) in FIG. 9). When the CPU receives the read data from the CPU 1, it stores the read data in the storage region of the cache CACHE which is related to the I2C device from which the read data have been read ((k) in FIG. 9). Then, the CPU changes the status of the cache CACHE which is related to the I2C device from which the read data have been read, to “2” (data received).

When the CPU receives a read request from the service processor SP after storing the read data in the cache CACHE, it sends an ACK and the read data stored in the cache CACHE to the service processor SP via the bus I2CB0 ((l) in FIG. 9). In this way, the service processor SP receives the read data from the I2C device in the expansion device EX1 within the retry time, so the read process is completed successfully.

As described above, even when a service processor SP and an I2C device (for example, a card C11) are separated by a distance that does not satisfy the specifications for the timing of a bus I2CB0, it is possible for the service processor SP to receive read data from the I2C device. For that purpose, a CPU receives read requests from the service processor SP at different timings, and outputs a read request command and read data to the CPU 1 and the service processor SP, respectively, in response to these read requests. This enables the service processor SP to receive read data from an I2C device in the expansion device EX1 or EX2 in conformity with the specifications for the timing of the bus I2CB0.

Even when an I2C device is installed outside a server SV, it is possible for a service processor SP to access the I2C device in conformity with the specifications for the timing of a bus I2CB0. Therefore, the service processor SP and the I2C device do not have to undergo redesigns. In other words, it is possible to install an additional I2C device in an expansion device EX1 or EX2 when the server SV does not a sufficient number of slots. Consequently, the service processor SP successfully accesses this additional I2C device without causing any malfunctions.

After sending the read data to the service processor SP, the CPU sets the status of the storage region in the cache CACHE from which the read data have been read to “0” (read request unsent). The read data stored in the corresponding storage region are thereby made invalid ((m) in FIG. 9). This makes it possible to keep the CPU from erroneously recognizing that valid read data are held in the cache CACHE when receiving a new read request to read other read data. Consequently, it is possible to avoid occurrences of malfunctions, such as the output of unwanted read data to the service processor SP.

FIG. 10 is another exemplary sequence diagram of reading data from an I2C device in the expansion device EX1 illustrated in FIG. 2. Note that the sequence of reading data from an I2C device in the expansion device EX2 will not be described, because it is substantially the same as that in FIG. 10.

FIG. 10 illustrates an exemplary case in which a failure occurs in one of the interface NWIF mounted on the card CARD1, the network NW1, the interfaces NWIF and I2CIF, the bus I2CB1, and the I2C device mounted in the expansion device EX1. In this case, the failure prohibits the CPU mounted on the card CARD1 from receiving read data. Accordingly, the sending of read requests and NACKs from the service processor SP and the CPU, respectively, is repeatedly performed ((a), (b), (c), (d), (e), and (f) in FIG. 10).

When the service processor SP receives no read data within the retry time, it decides that any failure has occurred in the card CARD1, the network NW1, or the expansion device EX1, and then performs a timeout process ((g) in FIG. 10). More specifically, when the service processor SP has received no data from the card CARD1 within a preset time since the output of a first read request, it detects that an error has occurred in reading read data from the I2C device in the expansion device EX1. This detection stops the service processor SP from repeatedly outputting read requests until it receives read data, so that its operation is kept from going into an infinite loop, such as hanging up.

The retry time is determined for each of the expansion devices EX1 and EX2, and depends on the response time determined based on the output of a communication check command from the CPU. In this way, the retry times may be individually set for the expansion devices EX1 and EX2, based on the cable lengths of the networks NW1 and NW2 and the like. For example, if a fixed retry time is set for both the networks NW1 and NW2 independently of their cable lengths and the like, it may be determined from the maximum allowable cable length of the networks NW1 and NW2. In this case, it takes a longer time for the service processor SP to decide the failure of an I2C device or the like in the expansion device EX1 or EX2 than when the individual retry times are set for the networks NW1 and NW2 depending on their cable lengths. This results in the decrease in the efficiency with which the service processor SP controls the server SV and the expansion devices EX1 and EX2.

A read request that the service processor SP sends to a CPU (I2C address=0x50 or 0x60) is defined as a request to monitor the measuring state of a response time. A write request that the service processor SP sends to a CPU is defined as a command for starting measuring a response time. This makes it possible to determine both the response time and the retry time that satisfy the specifications for the bus I2CB0 regarding the issue of read requests and write requests.

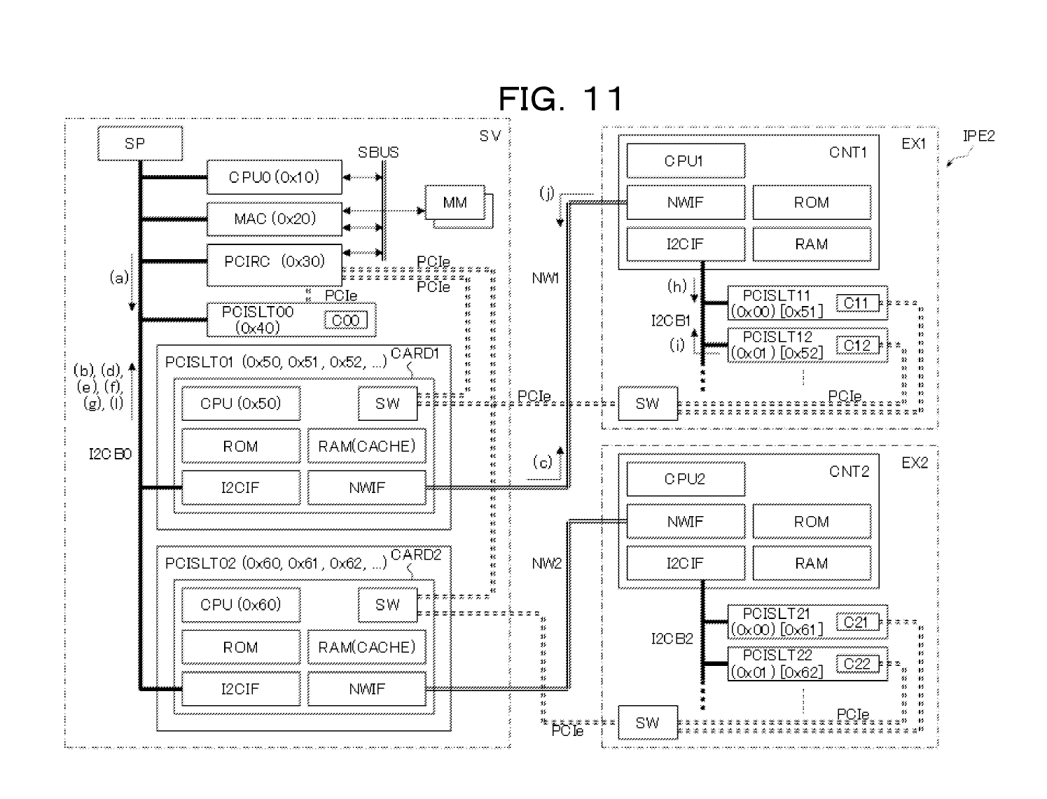

FIG. 11 illustrates an information flow in the sequence diagram illustrated in FIG. 9. The reference characters (a), (b), (c), (d), (e), (f), (g), (h), (i), (j), and (l) in FIG. 11 denote the same processes as those in FIG. 9.

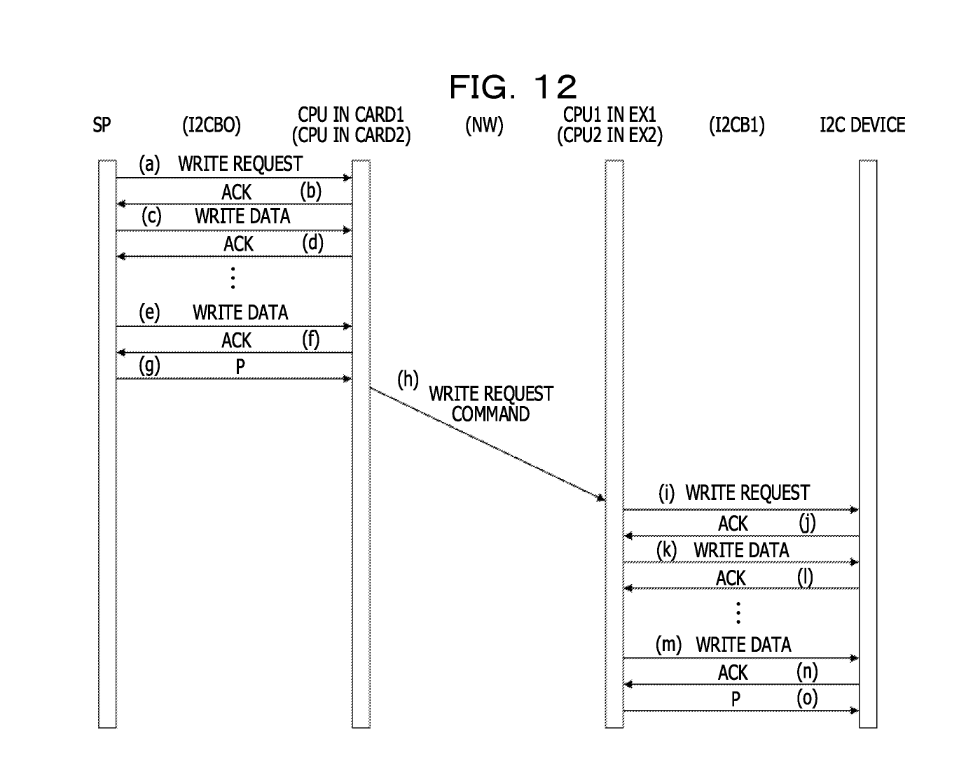

FIG. 12 is an exemplary sequence diagram of writing data to an I2C device in the expansion device EX1 illustrated in FIG. 2. Note that the sequence of writing data to an I2C device in the expansion device EX2 will not be described, because it is substantially the same as that in FIG. 12.

First, the service processor SP outputs a write request to the bus I2CB0 in order to write data to an I2C device in the expansion device EX1 ((a) in FIG. 12). For example, when data are written to the I2C device attached to the slot PCISLT11 as illustrated in FIG. 2, the service processor SP sets the I2C address contained in the write request to “0x51”. The CPU mounted on the card CARD1 recognizes that this write request is directed to the I2C device attached to the slot PCISLT11 (I2C address=0x01), based on the “0x51” contained therein. Then, the CPU converts the I2C address (0x51) received from the service processor SP into an I2C address (0x01) assigned to the expansion device EX1, for example, based on a conversion table for I2C addresses stored in the ROM or the RAM.

In response to the write request, the CPU sends an ACK to the service processor SP ((b) in FIG. 12). In response to the ACK, the service processor SP outputs write data to the bus I2CB0, and the CPU receives the write data ((c) in FIG. 12). After that, the service processor SP repeatedly receives ACKs and sends pieces of write data, whereas the CPU repeatedly sends the ACKs and receives the pieces of write data ((d), (e), and (f) in FIG. 12). For example, the CPU holds the received write data in the RAM. After the service processor SP receives the ACK corresponding to the final piece of write data, it outputs a stop command P to the bus I2CB0 ((g) in FIG. 12).

The CPU recognizes all the write data to be received, based on the stop command P. The CPU determines the length of the received write data. Then, the CPU sends the I2C address (for example, 0x01) of the I2C device to which the data will be written and a write request command containing the data length and the write data held in the RAM, to the CPU 1 mounted in the expansion device EX1 via the network NW1 ((h) in FIG. 12).

The CPU 1 mounted in the expansion device EX1 holds the write data contained in the write request command in the RAM or the like. The CPU 1 outputs a write request to the bus I2CB1 in order to write the data to the I2C device (I2C address=0x01) in accordance with the write request command ((i) in FIG. 12). When the I2C address contained in the write request is identical to that of the I2C device to which the data will be written, the I2C device sends an ACK to the CPU 1 in response to the write request ((j) in FIG. 12).

The CPU 1 outputs the write data (1 byte) held in the RAM or the like to the bus I2CB1 in response to the ACK. Then, the I2C device to which the data are to be written receives the write data ((k) in FIG. 12). After that, the CPU 1 repeatedly receives ACKs and sends pieces of write data (1 byte), whereas the I2C device to which the data will be written repeatedly sends the ACKs and receives the pieces of write data ((l), (m), and (n) in FIG. 12). After receiving the ACK corresponding to the final piece of write data, the CPU 1 outputs a stop command P (stop condition) to the bus I2CB1 ((o) in FIG. 12). Through the above procedures, the sequence in which the service processor SP writes data to an I2C device in the expansion device EX1 is completed.

FIG. 13 illustrates exemplary formats of a read request command, a write request command, and a communication check command illustrated in FIGS. 9, 12, and 5, respectively. Each of the read request command, the write request command, and the communication check command is a command that the CPU mounted on the card CARD1 outputs to the CPU 1 mounted in the expansion device EX1 via the network NW1.

A command code (0x01) is stored in the first byte of the read request command. The I2C address assigned to an I2C device from which data are to be read is stored in the higher seven bits in the second byte of the read request command, and the logic 1 (high level) indicating “read” is stored in the lowest bit in the second byte.

A command code (0x02) is stored in the first byte of the write request command. The I2C address assigned to an I2C device to which data are to be written is stored in the higher seven bits in the second byte of the write request command, and the logic 0 (low level) indicating “write” is stored in the lowest bit in the second byte. The data length (one of 1 to 254) of write data is stored in the third byte of the write request command, and the write data (254 byte maximum) are stored in the fourth and subsequent bytes.

A command code (0x10) is stored in the first byte of the communication check command, and an identification number is stored in the second byte.

FIG. 14 illustrates exemplary formats of a read data send command in FIG. 9 and a communication response command in FIG. 5. Each of these read data send command and communication response command is a command to be outputted from the CPU 1 to the CPU via the network NW1.

A command code (0x03) is stored in the first byte of the read data send command. The I2C address assigned to an I2C device from which data are to be read is stored in the higher seven bits in the second byte of the read data send command, and the logic 0 (low level) indicating “write to the CPU” is stored in the lowest bit in the second byte. The data length (one of 1 to 254) of read data is stored in the third byte of the read data send command; the read data (254 byte maximum) to be outputted to the CPU are stored in the fourth and subsequent bytes.

A command code (0x11) is stored in the first byte of the communication response command; an identification number is stored in the second byte.

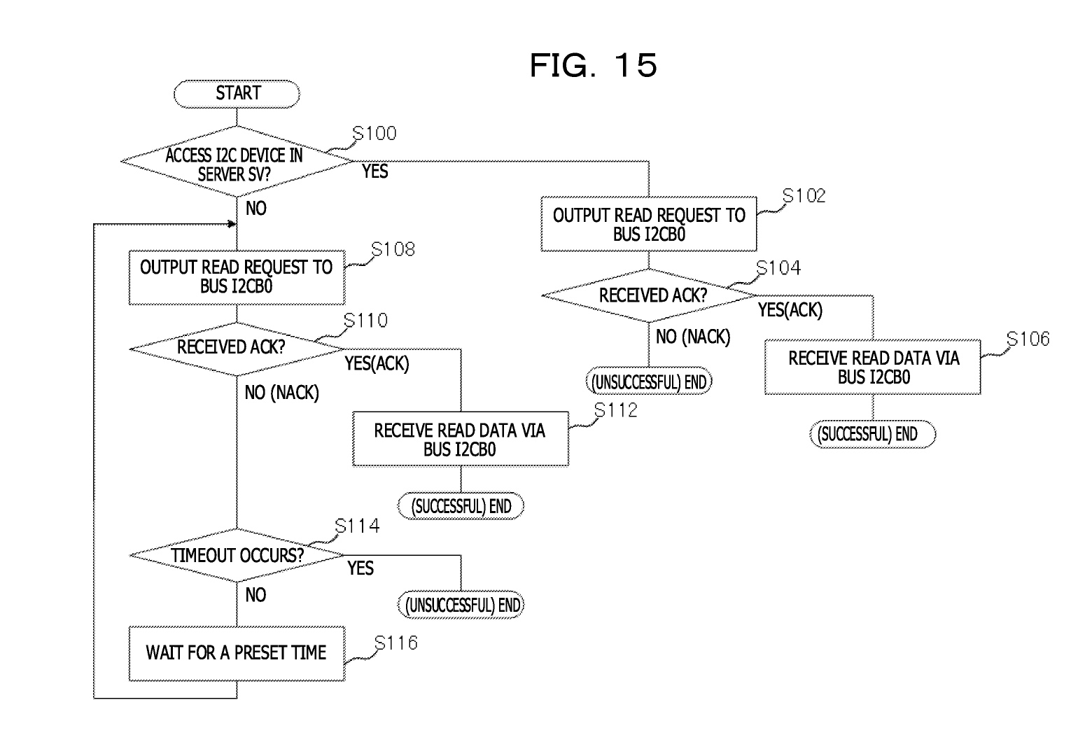

FIG. 15 depicts an exemplary read process performed by the service processor SP illustrated in FIG. 2. The process flow in FIG. 15 is implemented by causing the service processor SP to execute programs. FIG. 15 depicts an exemplary method of controlling an information processing device.

First, at a step S100, the service processor SP decides which an I2C device from which data will be read is mounted in the server SV or either of the expansion devices EX1 and EX2. If data will be read from an I2C device in the server SV, the service processor SP proceeds with a step S102. If data will be read from an I2C device in either of the expansion devices EX1 and EX2, the service processor SP proceeds with a step S108.

At the step S102, the service processor SP outputs a read request containing the I2C address assigned to the I2C device in the server SV, to the bus I2CB0. Next, at a step S104, the service processor SP decides whether to have received an ACK from the I2C device. If the service processor SP has received an ACK, it proceeds with a step S106. If the service processor SP has not received an ACK (or has received a NACK), it decides that the I2C device is defective, and then terminates the read process.

After receiving the ACK, at the step S106, the service processor SP receives read data via the bus I2CB0, and then terminates the read process. If the read data have multiple bits, the service processor SP repeatedly performs the steps S104 and S106.

If the service processor SP reads data from the I2C device in either the expansion device EX1 or EX2, it outputs a read request containing the I2C address (for example, 0x51) assigned to the I2C device, to the bus I2CB0 at a step S108. This read request is received by the CPU mounted in either the card CARD1 or CARD2.

Next, at a step S110, the service processor SP decides whether to have received an ACK. Here, an ACK and a NACK are outputted from the CPU mounted in either the card CARD1 or CARD2, as depicted in FIG. 9. If the service processor SP has received an ACK, the service processor SP proceeds with a step S112; if the service processor SP has not received an ACK (or has received a NACK), the service processor SP proceeds with a step S114.

After receiving the ACK, at the step S112, the service processor SP receives read data outputted from the CPU via the bus I2CB0, and then terminates the read process. If the read data have multiple bits, the service processor SP repeatedly performs the steps S110 and S112.

At the step S114, the service processor SP decides whether a timeout has occurred or not. If the timeout has occurred or if the retry time has passed as depicted in FIG. 10, the service processor SP decides that the I2C device or the route thereto is defective, and then terminates the read process. If the timeout has not occurred or if the retry time has not passed, the service processor SP proceeds with a step S116.

At the step S116, the service processor SP waits for a preset time, and then proceeds with the step S108. After that, the steps S108, S110, S114, and S116 are performed repeatedly. The steps S108, S110, S112, S114, and S116 correspond to the operations of the service processor SP in FIG. 9 or 10.

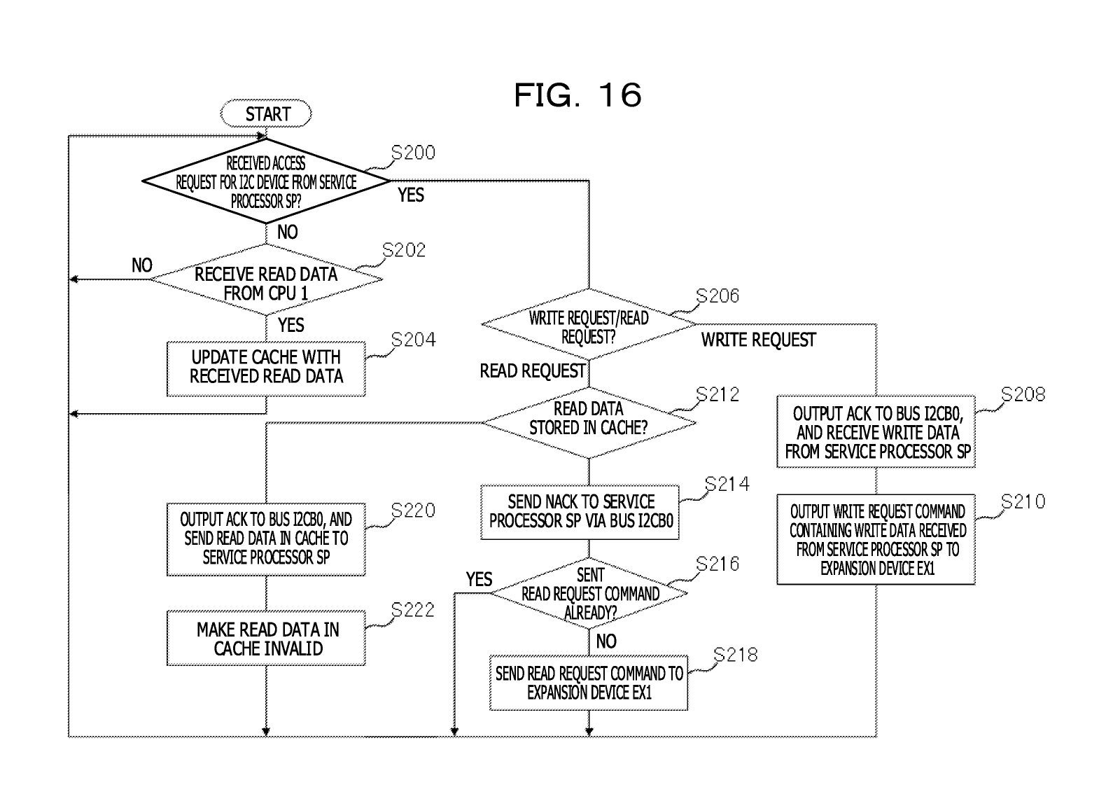

FIG. 16 depicts an exemplary operation of the CPU mounted on the card CARD1 as illustrated in FIG. 2. The process flow in FIG. 16 is implemented by causing the CPU mounted on the card CARD1 to execute programs. Note that the operation of the CPU mounted on the card CARD2 is implemented by replacing the expansion device EX1 and the CPU 1 in FIG. 16 with the expansion device EX2 and the CPU 2, respectively. FIG. 16 depicts an exemplary method of controlling an information processing device.

At a step S200, first, the CPU decides whether to have received an access request (read or write request) for an I2C device in the expansion device EX1 from the service processor SP. If the CPU has received an access request, it proceeds with a step S206; if the CPU has not received an access request, it proceeds with a step S202.

At the step S202, the CPU decides whether to have received read data from the CPU 1 mounted in the expansion device EX1. If the CPU has received read data, it proceeds with a step S204; if the CPU has not received read data, it returns the processing to the step S200. At the step S204, the CPU updates the cache CACHE with the received read data, and then returns the processing to the step S200.

At a step S206, the CPU decides whether the access request is a write request or a read request. If the CPU has received a write request, it proceeds with a step S208; if the CPU has received a read request, it proceeds with a step S212.

If the CPU has received a write request, it outputs an ACK to the bus I2CB0 and then receives write data from the service processor SP at the step S208, as depicted in FIG. 12. Next, at a step S210, the CPU outputs a write request command containing the write data received from the service processor SP, to the expansion device EX1 via the network NW1. After performing the step S210, the CPU returns the processing to the step S200.

If the CPU has received a read request, it decides whether or not any valid data are stored in the cache CACHE at a step S212. This decision about the presence of valid data in the cache CACHE depends on whether or not the status region in the cache CACHE, as illustrated in FIG. 8, is set to “2”. If any valid data are stored in the cache CACHE, the CPU proceeds with a step S220; if no valid data are stored in the cache CACHE, the CPU proceeds with a step S214.

At the step S214, the CPU sends a NACK to the service processor SP via the bus I2CB0. Next, at a step S216, the CPU decides whether to have already sent a read request command to the expansion device EX1. If the read request command has already been outputted, the CPU returns the processing to the step S200; if the read request command has not yet been outputted, the CPU returns the processing to a step S218. At the step S218, the CPU sends a read request command to the expansion device EX1 via the network NW1, and then returns the processing to the step S200.

If any valid data are stored in the cache CACHE, the CPU outputs an ACK to the bus I2CB0 and sends the read data in the cache CACHE to the service processor SP, at a step S220. Next, at the step S222, the CPU makes the read data in the cache CACHE, which has been outputted to the service processor SP, invalid, and then returns the processing to the step S200. For example, the read data stored in the cache CACHE are made invalid by setting the status region, as illustrated in FIG. 8, to “0”.

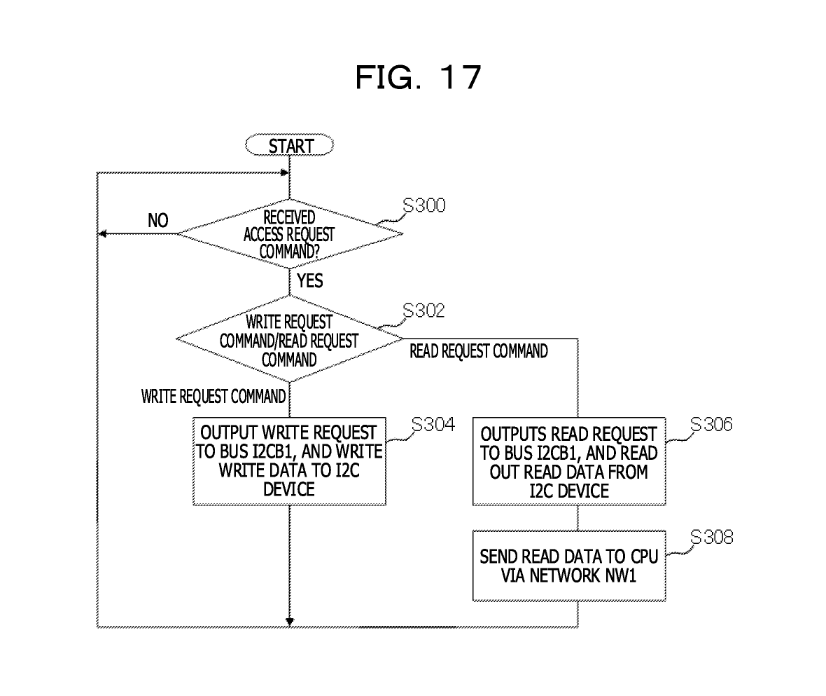

FIG. 17 depicts an exemplary operation of the CPU 1 mounted in the expansion device EX1 illustrated in FIG. 2. The process flow in FIG. 17 is implemented by causing the CPU 1 mounted in the expansion device EX1 to execute programs. The operation of the CPU 2 mounted in the expansion device EX2 is implemented by replacing the bus I2CB1, the CPU 1, the card CARD1, and the network NW1 with the bus I2CB2, the CPU 2, the card CARD2, and the network NW2. FIG. 17 depicts an exemplary method of controlling an information processing device.

At a step S300, first, the CPU 1 decides whether to have received an access request command (write or read request command) from the CPU mounted on the card CARD1 via the network NW1. If an access request command has been received, the CPU 1 proceeds with a step S302; if an access request command has not been received, the CPU 1 repeats the step S300.

At the step S302, then, the CPU 1 decides which the access request command is a write request command or a read request command. If the write request command has been received, the CPU 1 proceeds with the step S304; the read request command has been received, the CPU 1 proceeds with a step S306.

If the write request command has been received, the CPU 1 outputs a write request to the bus I2CB1 in accordance with the write request command, and then writes write data to the I2C device designated by the I2C address contained in the write request, at the step S304. After that, the CPU 1 returns the processing to the step S300.

If the read request command has been received, the CPU 1 outputs a read request to the bus I2CB1, and then reads read data from the I2C device designated by the I2C address contained in the read request, at a step S306. At a step S308, next, the CPU 1 sends the read data having been read from the I2C device to the CPU mounted on the card CARD1 via the network NW1, and then returns the processing to the step S300.

As described above, this embodiment successfully produces the same effect as that illustrated in FIG. 1. More specifically, when an I2C device is mounted on either an expansion device EX1 or EX2, it is also possible for a service processor SP to receive read data from this I2C device in conformity with the specifications for the timing of a bus I2CB0. In other words, even when the timing at which an I2C device in either an expansion device EX1 or EX2 outputs read data does not satisfy the specification for the timing of a bus I2CB0 relative to a first read request, it is possible for a service processor SP to receive read data correctly.

In the embodiment in FIGS. 2 to 17, a CPU outputs read data to a service processor SP, and then makes the read data held in its cache CACHE invalid. In this way, any invalid read data in the cache CACHE is kept from being outputted from the CPU to the service processor SP in response to a following read request, thereby making it possible to avoid occurrences of malfunctions.

A CPU determines a response time in communication between a server SV and an expansion device EX1 or EX2 in response to a communication check command; the service processor SP sets a retry time in accordance with this response time. This enables the retry time to be set for each of the expansion devices EX1 and EX2, depending on the cable lengths of the networks NW1 and NW2 and the like.

When a retry time passes in the course of reading read data from an I2C device in either an expansion device EX1 or EX2, a service processor SP performs a timeout process. This timeout process stops the service processor SP from repeatedly outputting read requests, thus making it possible to keep its operation from going into an infinite loop, such as hanging up.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An information processing system comprising:
a first device;
a first relay device coupled to the first device via a first communication line, the first relay device configured to communicate with the first device in conformity with a first communication protocol;
a second relay device coupled to the first relay device via a second communication line, the second relay device configured to communicate with the first relay device in conformity with a second communication protocol; and
a second device coupled to the second relay device via a third communication line, the second device configured to communicate with the second relay device in conformity with the first communication protocol, wherein
the first device outputs a first access request,
the first relay device converts the first access request, which is received via the first communication line, into a second access request conforming to the second communication protocol and outputs the second access request,
the second relay device converts the second access request, which is received via the second communication line, into a third access request conforming to the first communication protocol and outputs the third access request,
the second device outputs data, based on the third access request, and
the first relay device receives the data via the second relay device and holds the data, after which the first relay device receives a fourth access request from the first device and outputs the data held therein to the first device.

2. The information processing system according to claim 1, wherein
the fourth access request is an access request having the same content as the first access request.

3. The information processing system according to claim 2, wherein
before receiving the data, the first relay device receives a fifth access request that has the same content as the first access request from the first device and outputs, to the first device, information which indicates that the fifth access request is invalid.

4. The information processing system according to claim 2, wherein
after outputting the data held therein to the first device, the first relay device makes the data held therein invalid.

5. The information processing system according to claim 2, wherein
when not receiving the data within a preset time after the first access request was outputted, the first device detects that an error has occurred when reading the data from the second device.

6. The information processing system according to claim 5, wherein
when receiving a first command from the first device, which gives an instruction to measure a response time in communication between the first relay device and the second relay device, the first relay device outputs a second command for checking a communication state to the second relay device and determines, as the response time, a time elapsed before receiving a response to the second command from the second relay device, and
the preset time is a sum of the response time and a time taken for the second relay device to output the third access request and then receive the data from the second device.

7. The information processing system according to claim 6, wherein
the first relay device outputs an indication information to the first device in response to reception of a third command from the first device, the indication information indicating either that the response time is not measured, that the response time is being measured, and the response time,
when receiving the information indicating that the response time is not measured, from the first relay device in response to the third command, the first device outputs the first command, and
when receiving the information indicating that the response time is being measured, from the first relay device in response to the third command, the first device repeatedly outputs third commands until reception of the information indicating the response time.

8. The information processing system according to claim 6, wherein
the first device and the first relay device are mounted in a first information processing device, and
the first information processing device includes
a printed circuit board,
a connector mounted on the printed circuit board, the connector being coupled to the first communication line wired up to the printed circuit board, and configured to attach the first relay device, and
a detecting section mounted on the printed circuit board, the detecting section configured to detect contact with the first relay device attached to the connector, wherein
when the detecting section detects the attaching of the first relay device to the connector, the first device performs a process of measuring the response time.

9. The information processing system according to claim 8, wherein
the second relay device, the second device, and the third communication line are mounted in a second information processing device.

10. The information processing system according to claim 2, wherein
the first device and the first relay device operate as a master and a slave, respectively, over the first communication line, and
the second relay device and the second device operate as a master and a slave, respectively, over the third communication line.

11. An information processing method using an information processing system, the information processing system including a first device, a first relay device coupled to the first device via a first communication line, the first relay device configured to communicate with the first device in conformity with a first communication protocol, a second relay device coupled to the first relay device via a second communication line, the second relay device configured to communicate with the first relay device in conformity with a second communication protocol, and a second device coupled to a second relay device via a third communication line, the second device configured to communicate with the second relay device in conformity with the first communication protocol, the information processing method comprising:
outputting a first access request by the first device;
converting the first access request into a second access request conforming to the second communication protocol by using the first relay device, the first access request being received via the first communication line;
converting the second access request into a third access request conforming to the first communication protocol by using the second relay device, the second access request being received via the second communication line;
outputting data by the second device, based on the third access request;
receiving the data via the second relay device by using the first relay device, and holding the data in the first relay device;
receiving a fourth access request from the first device by using the first relay device; and
outputting, by using the first relay device, the data held in the first relay device to the first device.
